(19) United States
(12) Patent Application Publication
(10) Pub. No.: US 2019/0252825 A1
(43) Pub. Date: Aug. 15, 2019

(54) CONNECTOR ASSEMBLY

(71) Applicant: JAPAN AVIATION ELECTRONICS INDUSTRY, LIMITED, Tokyo (JP)

(72) Inventors: Kosuke MATSUO, Tokyo (JP); Atsushi TANAKA, Tokyo (JP); Shinichiro NAKAJIMA, Tokyo (JP)

(73) Assignee: JAPAN AVIATION ELECTRONICS INDUSTRY, LIMITED, Tokyo (JP)

(21) Appl. No.: 16/332,945

(22) PCT Filed: Jun. 5, 2017
(86) PCT No.: PCT/JP2017/020745

§ 371 Date: Mar. 13, 2019

(30) Foreign Application Priority Data
Oct. 13, 2016 (JP) 2016-201647

(51) Int. Cl. H01R 13/52; H01R 12/77; H01R 13/627; H01R 13/24

(52) U.S. Cl. CPC H01R 13/5219; H01R 12/771; H01R 12/78; H01R 13/24; H01R 13/6271

(57) ABSTRACT

A connector assembly of the present invention includes a first connector having a first electrical-connection member arranged on a base member, and a second connector having a second electrical-connection member arranged on a base member at a position opposite that of the first electrical-connection member. The first connector and the second connector further include engagement members at positions opposite each other. The first electrical-connection member includes an elastic protrusion and a first electrode arranged at a tip of the protrusion. The second electric-connection member includes a recess and a second electrode arranged at a bottom of the recess. At least one of the base member of the first connector and the base member of the second connector has flexibility. When the engagement members engage, the first electrode and the second electrode are brought into contact, and the protrusion and the recess are brought into contact.

TECHNICAL FIELD

The present invention relates to a connector assembly used to take out an electrical signal from a device that is attached to clothing or a human body.

### BACKGROUND ART

As a connector used to take out an electrical signal from a device that is attached to clothing or a human body, technology such as that described in Patent Literature 1 has been known. FIG. 1 shows FIG. 2 illustrated in Patent Literature 1. The abstract of Patent Literature 1 describes, as a problem, “providing a connector that can prevent the sense of wearing and durability from being impaired”, and as solving means, “a snap-button connector includes a first cloth 1 having electrical conductivity, a second cloth 2 having electrical conductivity, a snap button 3 that detachably connects the other end of the first cloth 1 and the other end of the second cloth 2 mechanically and electrically. This snap button 3 includes a male snap button 4 connected to the first cloth 1 mechanically and electrically and made of a material having electrical conductivity, and a female snap button 5 connected to the second cloth 2 mechanically and electrically and made of a material having electrical conductivity”. Conventional technology for resin fasteners includes that described in Patent Literature 2 and 3.

### PRIOR ART LITERATURE

### Patent Literature

Patent Literature 1: Japanese Patent Application Laid Open No. 2015-135723

Patent Literature 2: Japanese Patent Application Laid Open No. 2005-225516

Patent Literature 3: Japanese Patent Application Laid Open No. 2006-55280

### SUMMARY OF THE INVENTION

### Problems to be Solved by the Invention

The technology described in Patent Literature 1 provides a wearable-device connector attached to clothing or a human body, but its electrical-connection members do not have drip-proof structures (structures that prevent water drops from adhering thereto). Therefore, the connector has a problem in that the electrical-connection members tend to deteriorate due to water drops adhering thereto in living environments.

An object of the present invention is to provide a connector assembly having waterproofness at least in living environments.

### Means to Solve the Problems

A connector assembly of the present invention includes a first connector having a first electrical-connection member arranged on a base member, and a second connector having a second electrical-connection member arranged on a base member at a position opposite that of the first electrical-connection member. The first connector and the second connector further include engagement members at positions opposite each other. The first electrical-connection member includes an elastic protrusion and a first electrode arranged at a tip of the protrusion. The second electric-connection member includes a recess and a second electrode arranged at a bottom of the recess. At least one of the base member of the first connector and the base member of the second connector is flexible. When the engagement members engage, the first electrode and the second electrode are brought into contact, and the protrusion and the recess are brought into contact so as to prevent water from reaching the contact point of the first electrode and the second electrode.

### Effects of the Invention

According to a connector assembly of the present invention, since the first electrical-connection member and the second electrical-connection member easily provide positioning and water-tightness, waterproofness is provided at least in living environments.

### BRIEF DESCRIPTION OF THE DRAWINGS

FIG. 1 shows FIG. 2 illustrated in Patent Literature 1;

FIG. 2 is a plan of a first connector used in a first embodiment;

FIG. 3 is a rear view of the first connector used in the first embodiment;

FIG. 4 is a plan of a second connector used in the first embodiment;

FIG. 5 is a rear view of the second connector used in the first embodiment;

FIG. 6 is a cross-sectional view along VI-VI in FIG. 2;

FIG. 7 is a cross-sectional view along VII-VII in FIG. 4;

FIG. 8 is a cross-sectional view at the position indicated by VI-VI in FIG. 2 and VII-VII in FIG. 4 when the first connector and the second connector used in the first embodiment are joined;

FIG. 9 is a view showing a first example of a method in which a first electrode 121ₙ and a conductor 123ₙ are electrically connected;

FIG. 10 is a view showing a second example of the method in which the first electrode 121ₙ and the conductor 123ₙ are electrically connected;

FIG. 11 is a view showing a third example of the method in which the first electrode 121ₙ and the conductor 123ₙ are electrically connected;

FIG. 12 is a plan of a first connector used in a second embodiment;

FIG. 13 is a rear view of the first connector used in the second embodiment;

FIG. 14 is a plan of a second connector used in the second embodiment and a third embodiment;

FIG. 15 is a rear view of the second connector used in the second and third embodiments;

FIG. 16 is a cross-sectional view along XVI-XVI in FIG. 12;

FIG. 17 is a cross-sectional view along XVII-XVII in FIG. 14;

FIG. 18 is a cross-sectional view at the position indicated by XVI-XVI in FIG. 12 and XVII-XVII in FIG. 14 when the first connector and the second connector used in the second embodiment are joined;

FIG. 19 is a plan of a first connector used in the third embodiment;

FIG. 20 is a rear view of the first connector used in the third embodiment;

FIG. 21 is a cross-sectional view along XXI-XXI in FIG. 19; and

FIG. 22 is a cross-sectional view at the position indicated by XXI-XXI in FIG. 19 and XVII-XVII in FIG. 14 when the first connector and the second connector used in the third embodiment are joined.

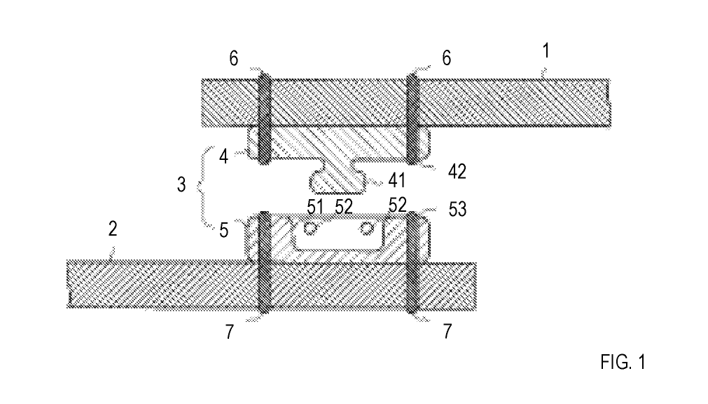

### DETAILED DESCRIPTION OF THE EMBODIMENTS

Embodiments of the present invention will be described below in detail. Identical numbers are assigned to components having identical functions, and a duplicate description thereof will be omitted.

### First Embodiment

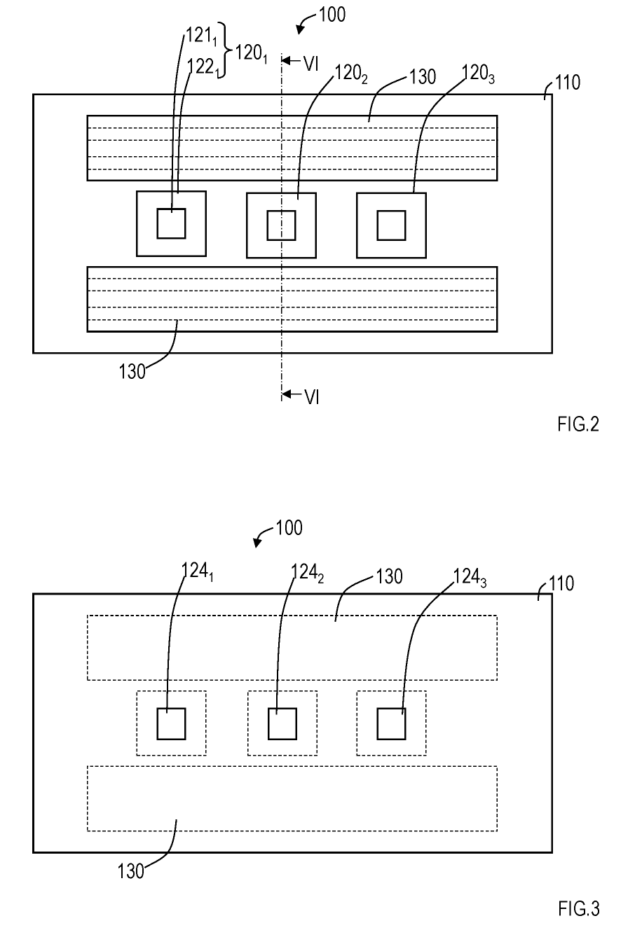

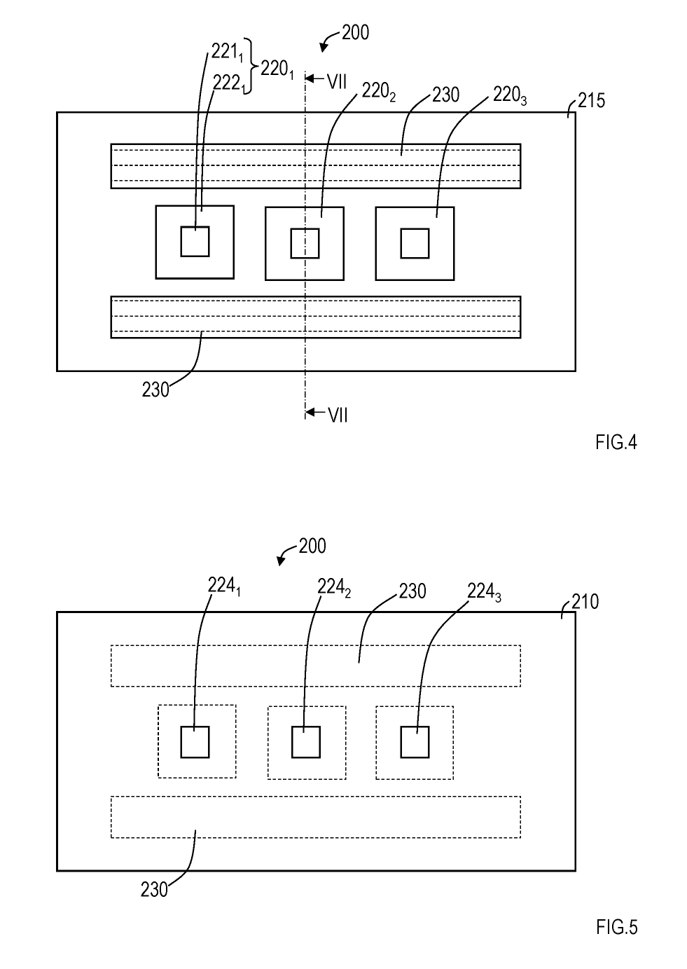

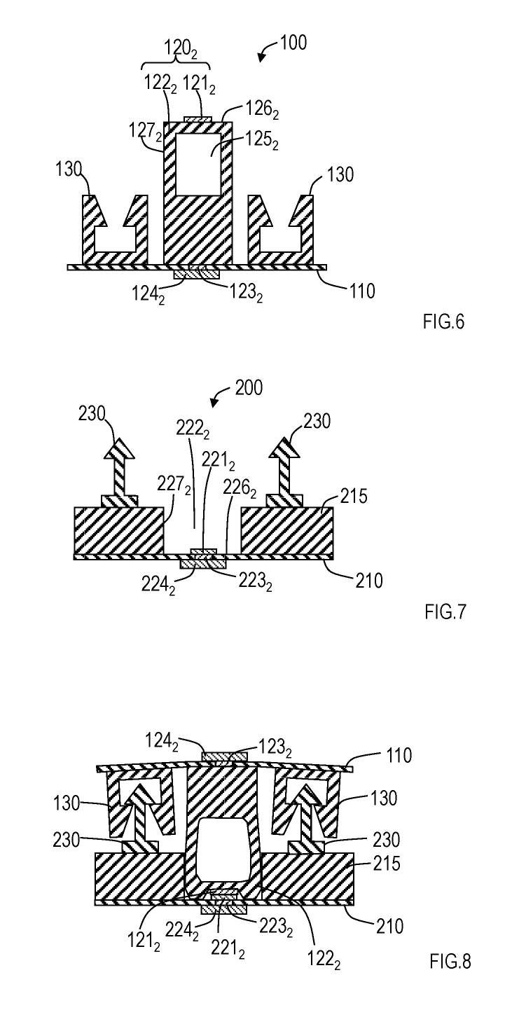

FIG. 2 is a plan of a first connector used in a first embodiment. FIG. 3 is a rear view of the first connector. FIG. 4 is a plan of a second connector used in the first embodiment. FIG. 5 is a rear view of the second connector. FIG. 6 is a cross-sectional view along VI-VI in FIG. 2. FIG. 7 is a cross-sectional view along VII-VII in FIG. 4. FIG. 8 is a cross-sectional view at the position indicated by VI-VI in FIG. 2 and VII-VII in FIG. 4 when the first connector and the second connector used in the first embodiment are joined. The first connector shown in FIG. 6 is illustrated up-side down in FIG. 8.

A connector assembly according to the first embodiment includes a first connector 100 and a second connector 200. The first connector 100 includes first electrical-connection members 120₁ to 120_{N} (N is an integer equal to or larger than 1;N=3 in FIGS. 2 and 3) arranged on a base member 110. The second connector 200 includes second electrical-connection members 220₁ to 220_{N} (N=3 in FIGS. 4 and 5) on a base member 210 at the positions opposite those of the first electrical-connection members 120₁ to 120_{N}. N equals 3 in FIGS. 2 to 5, but it is not limited to that value and should be set to a required value. In FIGS. 6 to 8, the first electrical-connection members 120₁ to 120_{N} are directly arranged on the base member 110, and the second electrical-connection members 220₁ to 220_{N} are directly arranged on the base member 210. Here, “being arranged on the base member” means not only being directly arranged on the base member but also being indirectly arranged on the base member with another member placed between the base member and the electrical-connection members (this also applies to second and third embodiments).

At least one of the base member 110 of the first connector 100 and the base member 210 of the second connector 200 has flexibility. Both the base member 110 and the base member 210 can have flexibility. Materials used for a flexible base member include a film such as films of polyimide, polyester, polypyrene, polystyrene, polyethylene, and vinyl chloride. Materials used for a non-flexible base member include thermosetting plastic, such as phenolic resin, epoxy, melanin, and polyurethane, general-purpose plastic, such as polyethylene, Teflon (registered trademark), ABS resin, and acrylic resin, and engineering plastic, such as nylon polycarbonate and liquid crystal polymer.

The first connector 100 and the second connector 200 further include engagement members 130 and engagement members 230, respectively, at positions opposite to each other. The engagement members 130 and 230 are shown in FIGS. 2 to 8. The engagement members 130 have recesses, as shown in FIG. 6, the engagement members 230 have protrusions, as shown in FIG. 7, and the engagement members engage, as shown in FIG. 8. In this embodiment, the engagement members 130 are arranged on the base member 110, and the engagement members 230 are arranged on a recess forming part 215. The protrusions and the recesses of the engagement members may be made reversely (the engagement members 230 may be disposed in the first connector 100 and the engagement members 130 may be disposed in the second connector 200). When a resin fastener having such a shape is used for the engagement members, for example, they can be easily attached and detached. A thermoplastic resin should be used, such as low-density polyethylene, ethylene-α-olefin copolymer, ethylene-vinyl-acetate copolymer, ethylene-acrylic-acid copolymer, and ethylene-acrylic-acid-ester copolymer. When the engagement members are made of resin, the engagement members should be secured to the base member 110 or the recess forming part 215 by adhesive or thermal fusion. Patent Literature 2 and 3, and other documents describe resin fasteners in detail. In the connector assembly of the present application, since it is not requisite that the engagement members be water-tight, the engagement members may have another shape, such as that of buttons.

The first electrical-connection members 120ₙ and the second electrical-connection members 220ₙ (n is an integer equal to or larger than 1 and equal to or smaller than N; n=2 in FIGS. 6 to 8) will be described by referring to FIGS. 6 to 8. The first electrical-connection member 120ₙ includes an elastic protrusion 122ₙ and a first electrode 121ₙ disposed at a tip 126ₙ of the protrusion 122ₙ. In an example shown in FIG. 6, a space 125ₙ is formed to make the protrusion 122ₙ hollow. Since the protrusion 122ₙ is made hollow, it is deformed more easily. The second electrical-connection member 220ₙ includes a recess 222ₙ and a second electrode 221ₙ disposed at a bottom 226ₙ of the recess 222_{g}. The recess 222ₙ is formed by providing the recess forming part 215 on the base member 210. When the engagement members 130 and 230 engage as shown in FIG. 8, the first electrode 121ₙ and the second electrode 221ₙ are brought into contact. Since at least the protrusion 122ₙ is deformed, at least part of the side face 127ₙ of the protrusion 122ₙ touches the side face 227ₙ of the recess 222ₙ over the perimeter. Therefore, water-tightness is provided, and water from the outside is prevented from reaching the contact point of the first electrode 121ₙ and the second electrode 221ₙ. In addition, in the example shown in FIG. 8, the tip 126ₙ of the protrusion 122ₙ, except for the portion where the first electrode 121ₙ is formed, touches the bottom 226ₙ of the recess 222ₙ, except for the portion where the second electrode 221ₙ is formed, so as to surround the first electrode 121ₙ and the second electrode 221ₙ. Water-tightness is also provided with this contact that surrounds the first electrode 121ₙ and the second electrode 221ₙ, and water from the outside is prevented from reaching the contact point of the first electrode 121ₙ and the second electrode 122ₙ. In the example shown in FIG. 8, water-tightness is provided at the two locations, but either of them may be used. As described above, since the connector assembly of the first embodiment provides water-tightness by bringing the protrusions 122ₙ and the recesses 222ₙ into contact, the connector assembly has waterproofness at least in living environments.

When the protrusion 122ₙ is soft, and when the engagement members 130 and 230 engage, if the protrusion 122ₙ and the recess 222ₙ are brought into contact to provide water-tightness, the recess 222ₙ may be non-elastic. If the elasticity of the protrusion 122ₙ itself alone does not provide water-tightness, however, the recess 222ₙ should be elastic. The recess 222ₙ being elastic means the recess forming part 215 being elastic. When the recess 222ₙ is elastic, rubber materials can be used for the recess forming part 215 and the protrusions 122,, such as elastomer, polyurethane, polyester, polyamide, polystyrene, polyolefin, vinyl chloride, styrene-butadiene rubber, chloroprene rubber, ethylene propylene rubber silicone, and fluororubber. When the recess 222ₙ is non-elastic, any of the materials used for the non-flexible base member, described above, should be used for the recess forming part 215, and the base member 210 and the recess forming part 215 may be formed as a unit. In FIGS. 2 to 8, both the protrusions 122ₙ and the recesses 222ₙ are rectangular and the corners are explicitly illustrated. Both the protrusions 122ₙ and the recesses 222ₙ, however, may be rounded at the corners. In the protrusions 122ₙ, the tips 126ₙ may be rounded on the whole.

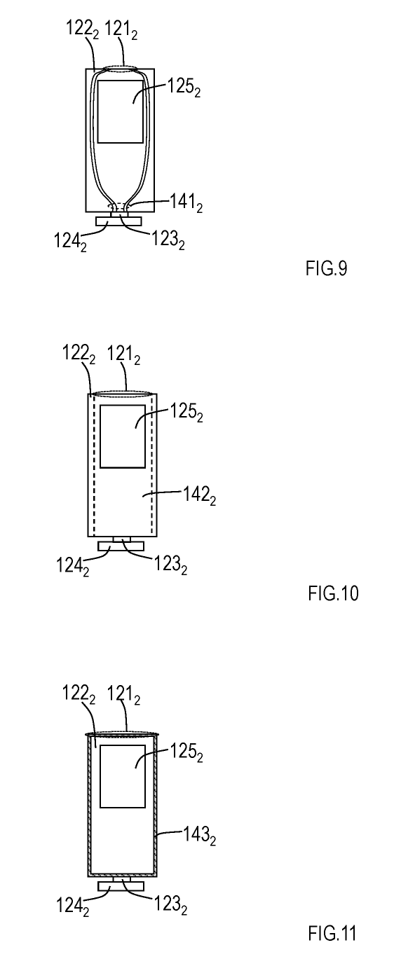

Although not shown in FIGS. 6 and 8, the first electrode 121ₙ is electrically connected to a terminal 124.ₙ via a conductor 123ₙ formed in a through-hole of the base member 110 by some method. FIGS. 9 to 11 show examples of a method for electrically connecting the first electrode 121ₙ and the conductor 123ₙ. In the example shown in FIG. 9, the first electrode 121ₙ and the conductor 123ₙ are connected by a plurality of conductive thin wires 141ₙ disposed inside the protrusion 122ₙ. The conductive thin wires 141ₙ are deformable as the protrusion 122ₙ is deformed. In the example shown in FIG. 9, a portion (portion surrounded by a dotted line) of the conductive thin wires 141ₙ exposed from the tip 126ₙ of the protrusion 122ₙ serves as the first electrode 121ₙ. Therefore, the first electrode 121ₙ shown in FIGS. 6 and 8 is not shown in FIG. 9. In the example shown in FIG. 10, the first electrode 121ₙ and the conductor 123ₙ are connected by an electrically conductive rubber 142ₙ. In the example shown in FIG. 10, a portion (portion surrounded by a dotted line) where the electrically conductive rubber 142ₙ is exposed from the tip 126ₙ of the protrusion 122ₙ serves as the first electrode 121ₙ. Therefore, the first electrode 121ₙ shown in FIGS. 6 and 8 is not shown in FIG. 10, either. In the example shown in FIG. 11, the first electrode 121ₙ and the conductor 123ₙ are connected by an electrically conductive thin film 143ₙ formed in the area surrounding the protrusion 122ₙ. In the example shown in FIG. 11, the electrically conductive thin film 143ₙ formed at the tip 126ₙ of the protrusion 122ₙ serves as the first electrode 121ₙ. The method for electrically connecting the first electrode 121ₙ and the conductor 123ₙ is not necessarily limited to the above-described three methods. As shown in FIGS. 7 and 8, the second electrode 221ₙ is electrically connected to a terminal 224ₙ via a conductor 223ₙ formed in a through-hole of the base member 210. Either one of the terminal 124ₙ and the terminal 224ₙ is connected to a device attached to clothing or a human body, and the other is connected to an outside measuring instrument or another apparatus.

According to the connector assembly of the first embodiment, since the first electrical-connection members and the second electrical-connection members easily provide positioning and water-tightness, waterproofness is provided at least in living environments. In the above embodiment, the engagement members are a resin fastener as an example. Since the engagement members are not required to be waterproof, an appropriate one(s) should be selected on the basis of the use.

### Second Embodiment

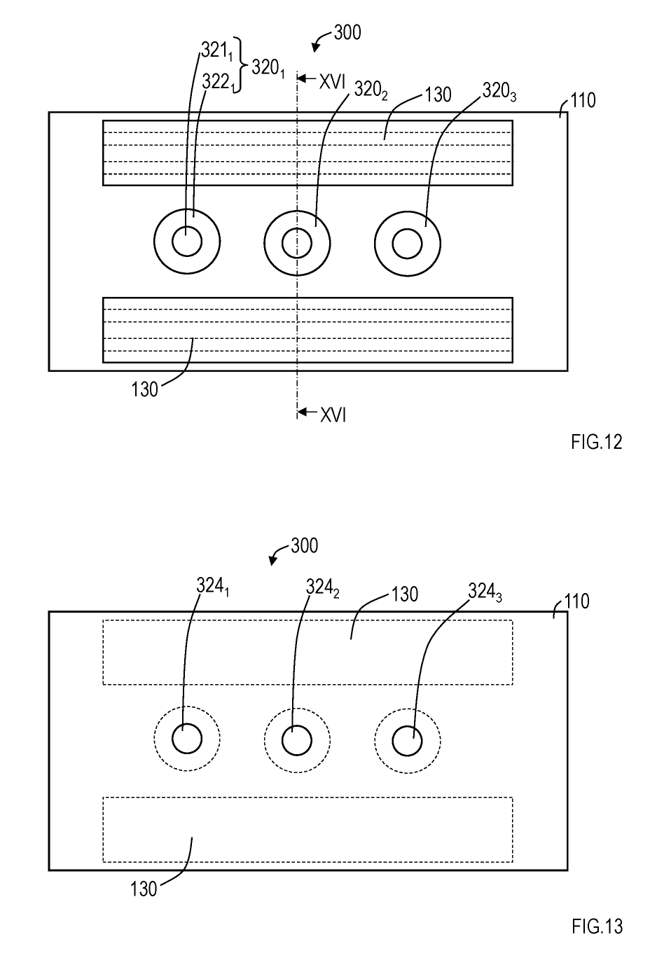

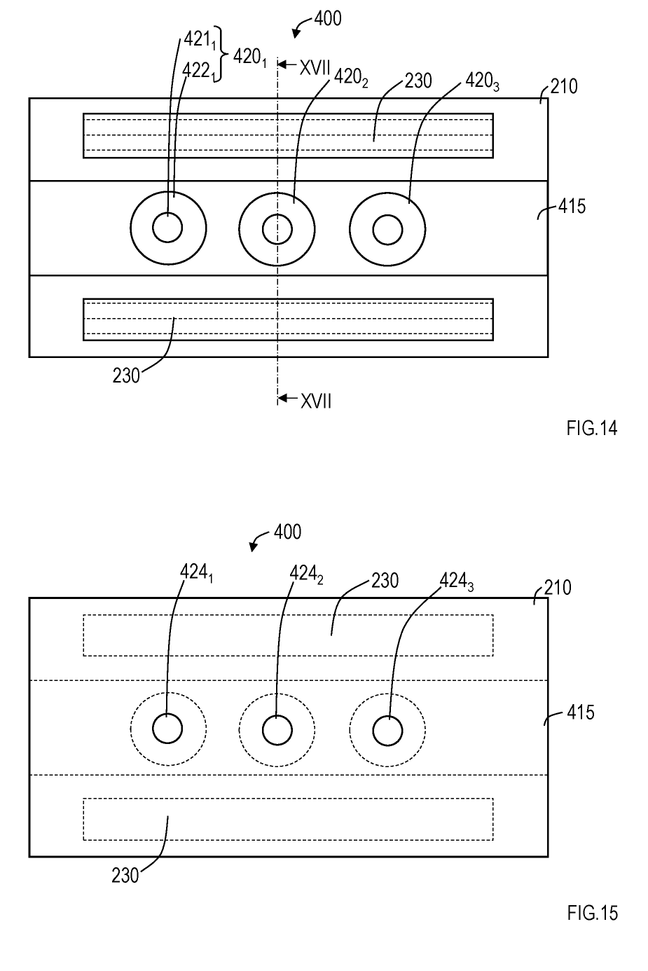

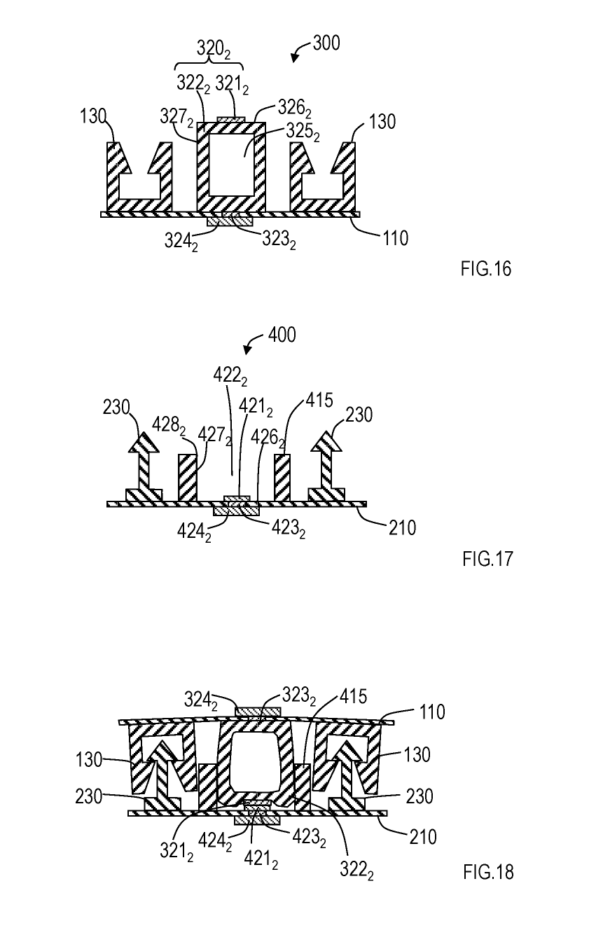

FIG. 12 is a plan of a first connector used in a second embodiment. FIG. 13 is a rear view of the first connector. FIG. 14 is a plan of a second connector used in the second embodiment. FIG. 15 is a rear view of the second connector. FIG. 16 is a cross-sectional view along XVI-XVI in FIG. 12. FIG. 17 is a cross-sectional view along XVII-XVII in FIG. 14. FIG. 18 is a cross-sectional view at the position indicated by XVI-XVI in FIG. 12 and XVII-XVII in FIG. 14 when the first connector and the second connector used in the second embodiment are joined. The first connector shown in FIG. 16 is illustrated up-side down in FIG. 18.

A connector assembly according to the second embodiment includes a first connector 300 and a second connector 400. The first connector 300 includes first electrical-connection members 320₁ to 320_{N} (N is an integer equal to or larger than 1; N=3 in FIGS. 12 and 13) arranged on a base member 110. The second connector 400 includes second electrical-connection members 420₁ to 420_{N} (N=3 in FIGS. 14 and 15) on a base member 210 at the positions opposite those of the first electrical-connection members 320₁ to 320_{N}. N equals 3 in FIGS. 12 to 15, but it is not limited to that value and should be set to a required value. The second embodiment differs from the first embodiment in that the first electrical-connection members 320₁ to 320_{N} and second electrical-connection members 420₁ to 420_{N} are cylindrical, and engagement members 230 are disposed on the base member 210. Because of the latter difference, a recess forming part 415 is narrow and protrusions 322₁ to 322_{N} are low. Therefore, the connector assembly of the second embodiment is thinner than the connector assembly of the first embodiment in the engaged state.

The base member 110 and the base member 210 are the same as those in the first embodiment. Engagement members 130 and 230 of the second embodiment differ from those of the first embodiment only in that the engagement members 230 are directly disposed on the base member 210. Also in the second embodiment, since it is not requisite that the engagement members be water-tight, the engagement members may have another shape, such as that of buttons.

The first electrical-connection members 320ₙ and the second electrical-connection members 420ₙ (n is an integer equal to or larger than 1 and equal to or smaller than N; n=2 in FIGS. 16 to 18) will be described by referring to FIGS. 16 to 18. The first electrical-connection member 320ₙ includes an elastic protrusion 322ₙ and a first electrode 321ₙ disposed at a tip 326ₙ of the protrusion 322ₙ. In an example shown in FIG. 16, a space 325ₙ is formed to make the protrusion 322ₙ hollow. Since the protrusion 322ₙ is made hollow, it is deformed more easily. The second electrical-connection member 420ₙ includes a recess 422ₙ and a second electrode 421ₙ disposed at a bottom 426ₙ of the recess 422ₙ. The recess 422ₙ is formed by providing the recess forming part 415 on the base member 210. When the engagement members 130 and 230 engage as shown in FIG. 18, the first electrode 321ₙ and the second electrode 421ₙ are brought into contact. Since at least the protrusion 322ₙ is deformed, at least part of the side face 327ₙ of the protrusion 322ₙ touches the side face 427ₙ of the recess 422ₙ over the perimeter thereof. Therefore, water-tightness is provided, and water from the outside is prevented from reaching the contact point of the first electrode 321ₙ and the second electrode 421ₙ. As described above, since the connector assembly of the second embodiment provides water-tightness by bringing the protrusions 322ₙ and the recesses 422ₙ into contact, the connector assembly has waterproofness at least in living environments. As in the first embodiment, the tip 326ₙ of the protrusion 322ₙ, except for the portion where the first electrode 321ₙ is formed, may touch the bottom 426ₙ of the recess 422ₙ, except for the portion where the second electrode 421ₙ is formed, so as to surround the first electrode 321ₙ and the second electrode 421ₙ. The recess 422ₙ may be elastic. In the protrusion 322ₙ, the tip 326ₙ may be rounded on the whole.

The first electrode 321ₙ is electrically connected to a terminal 324ₙ via a conductor 323ₙ formed in a through-hole of the base member 110 by some method. Specific examples of the connection method are the same as those in the first embodiment (FIGS. 9 to 11). As shown in FIGS. 17 and 18, the second electrode 421ₙ is electrically connected to a terminal 424ₙ via a conductor 423ₙ formed in a through-hole of the base member 210. Either one of the terminal 324ₙ and the terminal 424ₙ is connected to a device attached to clothing or a human body, and the other is connected to an outside measuring instrument or another apparatus. Since the connector assembly of the second embodiment has the above-described structure, it provides the same effect as the first embodiment.

### Third Embodiment

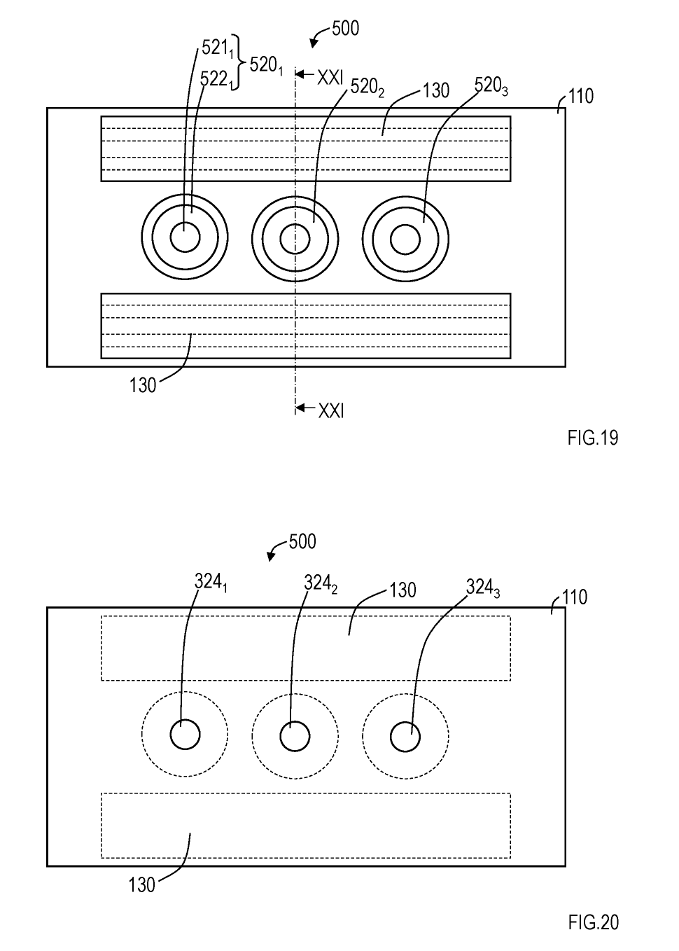

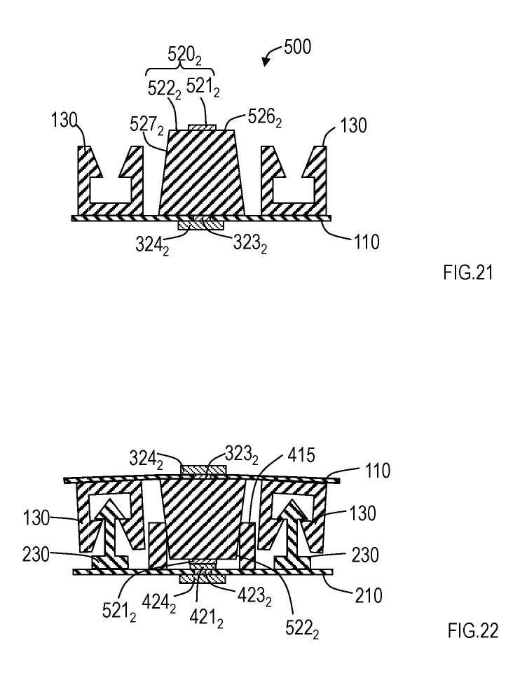

FIG. 19 is a plan of a first connector used in a third embodiment. FIG. 20 is a rear view of the first connector. FIG. 14 is a plan of a second connector used in the third embodiment. FIG. 15 is a rear view of the second connector. FIG. 21 is a cross-sectional view along XXI-XXI in FIG. 19. FIG. 22 is a cross-sectional view at the position indicated by XXI-XXI in FIG. 19 and XVII-XVII in FIG. 14 when the first connector and the second connector used in the third embodiment are joined. The first connector shown in FIG. 21 is illustrated up-side down in FIG. 22.

A connector assembly according to the third embodiment includes a first connector 500 and a second connector 400. The first connector 500 includes first electrical-connection members 520₁ to 520_{N} (N is an integer equal to or larger than 1; N=3 in FIGS. 19 and 20) arranged on a base member 110. The second connector 400 is the same as that in the second embodiment. N equals 3 in FIGS. 14, 15, 19, and 20, but it is not limited to that value and should be set to a required value. The third embodiment differs from the second embodiment in that protrusions 522ₙ are made narrower toward tips 526ₙ thereof.

The base member 110 and a base member 210 are the same as those in the first embodiment. Engagement members 130 and 230 of the third embodiment differ from those of the first embodiment only in that the engagement members 230 are directly disposed on the base member 210. Also in the third embodiment, since it is not requisite that the engagement members be water-tight, the engagement members may have another shape, such as that of buttons.

The first electrical-connection members 520ₙ and the second electrical-connection members 420ₙ (n is an integer equal to or larger than 1 and equal to or smaller than N; n=2 in FIGS. 17, 21, and 22) will be described by referring to FIGS. 17, 21, and 22. The first electrical-connection member 520ₙ includes an elastic protrusion 522ₙ having a shape narrowed toward the tip and a first electrode 521ₙ disposed at the tip 526ₙ of the protrusion 522ₙ. In an example shown in FIG. 21, the protrusion 522ₙ is not made hollow, but a space may be made in the protrusion 522ₙ, as in the first and second embodiments. The second electrical-connection member 420ₙ is the same as that of the second embodiment. When the engagement members 130 and 230 engage as shown in FIG. 22, the first electrode 521ₙ and the second electrode 421ₙ are brought into contact. The side face 527ₙ of the protrusion 522ₙ touches an opening 428ₙ of a recess 422ₙ over the perimeter thereof. Since at least the protrusion 522ₙ is elastic, it is easier to bring the first electrode 521ₙ and the second electrode 421ₙ into contact and to bring the side face 527ₙ of the protrusion 522ₙ and the opening 428ₙ of the recess 422ₙ into contact over the perimeter thereof. Therefore, water-tightness is provided, and water from the outside is prevented from reaching the contact point of the first electrode 521ₙ and the second electrode 421ₙ. As described above, since the connector assembly of the third embodiment provides water-tightness by bringing the protrusions 522ₙ and the recesses 422ₙ into contact, the connector assembly has waterproofness at least in living environments. As in the first embodiment, the tip 526ₙ of the protrusion 522ₙ, except for the portion where the first electrode 521ₙ is formed, may touch the bottom 426ₙ of the recess 422ₙ, except for the portion where the second electrode 421ₙ is formed, so as to surround the first electrode 521ₙ and the second electrode 421ₙ. The recess 422ₙ may be elastic. In the protrusion 522ₙ, the tip 526ₙ may be rounded on the whole.

The first electrode 521ₙ is electrically connected to a terminal 324ₙ via a conductor 323ₙ formed in a through-hole of the base member 110 by some method. Specific examples of the connection method are the same as those in the first embodiment (FIGS. 9 to 11). As shown in FIGS. 17 and 22, the second electrode 421ₙ is electrically connected to a terminal 424ₙ via a conductor 423ₙ formed in a through-hole of the base member 210. Either one of the terminal 324ₙ and the terminal 424ₙ is connected to a device attached to clothing or a human body, and the other is connected to an outside measuring instrument or another apparatus. Since the connector assembly of the third embodiment has the above-described structure, it provides the same effect as the first embodiment.

### DESCRIPTION OF REFERENCE NUMERALS

100, 300, 500: First connector

110, 210: Base member

120, 320, 520: First electrical-connection member

121, 321, 521: First electrode

122, 322, 522: Protrusion

123, 223, 323, 423: Conductor

124, 224, 324, 424: Terminal

125, 325: Space

126, 326, 526: Tip

127, 227, 327, 427, 527: Side face

130, 230: Engagement member

141: Conductive thin wire

142: Electrically conductive rubber

143: Electrically conductive thin film

200, 400: Second connector

215, 415: Recess forming part

220, 420: Second electrical-connection member

221, 421: Second electrode

222, 422: Recess

223, 423: Conductor

226, 426: Bottom

428: Opening

1. A connector assembly comprising:
a first connector having a first electrical-connection member arranged on a base member; and
a second connector having a second electrical-connection member arranged on a base member at a position opposite that of the first electrical-connection member;
the first connector and the second connector further comprising engagement members at positions opposite each other;
the first electrical-connection member comprising an elastic protrusion and a first electrode arranged at a tip of the protrusion;
the second electric-connection member comprising a recess and a second electrode arranged at a bottom of the recess;
at least one of the base member of the first connector and the base member of the second connector has flexibility; and
when the engagement members engage, the first electrode and the second electrode are brought into contact, and the protrusion and the recess are brought into contact so as to prevent water from reaching the contact point of the first electrode and the second electrode.

2. A connector assembly comprising:
a first connector having a first electrical-connection member arranged on a base member; and
a second connector having a second electrical-connection member arranged on a base member at a position opposite that of the first electrical-connection member;
the first connector and the second connector further comprising engagement members at positions opposite each other;
the first electrical-connection member comprising an elastic protrusion and a first electrode arranged at a tip of the protrusion;
the second electric-connection member comprising a recess and a second electrode arranged at a bottom of the recess;
at least one of the base member of the first connector and the base member of the second connector has flexibility; and
when the engagement members engage, the first electrode and the second electrode are brought into contact, and at least part of a side face of the protrusion is brought into contact with a side face of the recess over the perimeter thereof.

3. A connector assembly comprising:
a first connector having a first electrical-connection member arranged on a base member; and
a second connector having a second electrical-connection member arranged on a base member at a position opposite that of the first electrical-connection member;
the first connector and the second connector further comprising engagement members at positions opposite each other;
the first electrical-connection member comprising an elastic protrusion and a first electrode arranged at part of a tip of the protrusion;
the second electric-connection member comprising a recess and a second electrode arranged at part of a bottom of the recess;
at least one of the base member of the first connector and the base member of the second connector has flexibility; and
when the engagement members engage, the first electrode and the second electrode are brought into contact, and the tip of the protrusion, except for a portion where the first electrode is formed, is brought into contact with the bottom of the recess, except for a portion where the second electrode is formed, so as to surround the first electrode and the second electrode.

4. A connector assembly comprising:
a first connector having a first electrical-connection member arranged on a base member; and
a second connector having a second electrical-connection member arranged on a base member at a position opposite that of the first electrical-connection member;
the first connector and the second connector further comprising engagement members at positions opposite each other;
the first electrical-connection member comprising an elastic protrusion having a shape narrowed toward a tip and a first electrode arranged at the tip of the protrusion;
the second electric-connection member comprising a recess and a second electrode arranged at a bottom of the recess;
at least one of the base member of the first connector and the base member of the second connector has flexibility; and
when the engagement members engage, the first electrode and the second electrode are brought into contact, and a side face of the protrusion is brought into contact with an opening of the recess over the perimeter thereof.

5. The connector assembly according to claim 1, wherein the recess is also elastic.

6. The connector assembly according to claim 1, wherein both the base member of the first connector and the base member of the second connector have flexibility.

7. The connector assembly according to claim 1, wherein the protrusion is hollow.

8. The connector assembly according to claim 1, wherein the engagement members constitute a resin fastener.

9. The connector assembly according to claim 2, wherein the recess is also elastic.

10. The connector assembly according to claim 2, wherein both the base member of the first connector and the base member of the second connector have flexibility.

11. The connector assembly according to claim 2, wherein the protrusion is hollow.

12. The connector assembly according to claim 2, wherein the engagement members constitute a resin fastener.

13. The connector assembly according to claim 3, wherein the recess is also elastic.

14. The connector assembly according to claim 3, wherein both the base member of the first connector and the base member of the second connector have flexibility.

15. The connector assembly according to claim 3, wherein the protrusion is hollow.

16. The connector assembly according to claim 3, wherein the engagement members constitute a resin fastener.

17. The connector assembly according to claim 4, wherein the recess is also elastic.

18. The connector assembly according to claim 4, wherein both the base member of the first connector and the base member of the second connector have flexibility.

19. The connector assembly according to claim 4, wherein the protrusion is hollow.

20. The connector assembly according to claim 4, wherein the engagement members constitute a resin fastener.
